(19) United States
(12) Patent Application Publication
(10) Pub. No.: US 2016/0349152 A1
(43) Pub. Date: Dec. 1, 2016

(54) METHOD FOR ALIGNING COMPOSITE WORK CYCLE SEVERITY DISTRIBUTIONS TO SEVERITY RESPONSES

(71) Applicant: Caterpillar Inc., Peoria, IL (US)

(72) Inventors: Jeffry N. Sundermeyer, Dunlap, IL (US); Benjamin Hodel, Dunlap, IL (US); Nathan J. Wieland, Eureka, IL (US); Jim A. Nygaard, Washington, IL (US)

(73) Assignee: Caterpillar Inc., Peoria, IL (US)

(21) Appl. No.: 14/726,720

(22) Filed: Jun. 1, 2015

(51) Int. Cl. G01M 99/00

(52) U.S. Cl. CPC G01M 99/008

(57) ABSTRACT

A method for aligning composite work cycle seventies to target percentile severity responses includes selecting a set of machines to be monitored for severity, applying an operation classification corresponding to one or more machine operations performed by each machine in the set of machines, applying a severity indexing system to the set of machines, constructing a distribution of severity responses associated with an operation classification, receiving data from one or more performed damage simulations or tests and mapping a selected range of test event seventies for the operation classification to corresponding target actual seventies for the operation based upon performance of the operation by the machine.

### TECHNICAL FIELD

The present disclosure relates to composite work cycles and more particularly to aligning composite work cycle severity distributions to severity responses.

### BACKGROUND

Composite work cycles (CWC) are important aspects of product development and validation processes for many equipment manufacturers. CWCs may be defined as a carefully selected set of defined test events intended to map to a desired percentile in a severity response distribution. Unfortunately, the variability in equipment application and severity in the user base may be high and poorly understood. Accordingly, a defined composite work cycle may not closely map to desired severity percentiles. For example, a composite work cycle may suffer from unnecessary redundancy in event definition, or may be lacking a specified event to be input in order to accurately map to the desired percentile of severity.

U.S. Pat. No. 8,571,814 to Zhao discloses a structural load monitoring system incorporating a load monitoring reliability factor. According to one embodiment, Zhao provides a method including accessing distributions of flight loads associated with one or more flight regimes for a fleet of aircraft. Using the distributions of flight loads, a factor for a flight regime is determined that provides a flight load adjustment for a component on each aircraft of a fleet of aircraft known to be affected through load damage by the flight regime. Such structural health predictions are used to determine when to replace various aircraft components. However, Zhao does not relate to mapping severity test data to reported or measured severity data to ensure severity testing is performed at an appropriate level.

Accordingly, it is advantageous to provide improved severity estimates based on a relationship between severity distributions of CWC severity events and customer severity responses.

### SUMMARY OF THE INVENTION

According to an aspect of the disclosure, a method for aligning composite work cycle severity distributions to target percentile severity responses includes selecting a set of machines to be monitored for severity, applying an operation classification corresponding to one or more machine operations performed by each machine in the set of machines, applying a severity indexing system to the set of machines, constructing a distribution of severity responses associated with an operation classification, receiving data from one or more performed damage simulations or tests, and mapping a selected range of test event severities for the operation classification to corresponding target actual severities for the operation based upon performance of the operation by the machine.

According to one aspect of the disclosure, a method for aligning composite work cycle severity distributions to target percentile severity responses includes selecting a set of machines to be monitored for severity; applying an operation classification corresponding to a machine operation for each machine in the set of machines; applying a severity indexing system to the set of machines; constructing a distribution of severity responses associated with the operation classification; mapping a selected range of test event severities for the operation classification to corresponding target actual severities for the operation based upon performance of the operation by the machine; and verifying that a target range of test event severities is met using the mapping.

According to one aspect of the disclosure, a computer-readable medium is provided. A processor may be configured to execute instructions stored on a computer-readable medium to perform a method for aligning composite work cycle severity distributions to target percentile severity responses includes selecting a set of machines to be monitored for severity; applying an operation classification corresponding to a machine operation for each machine in the set of machines; applying a severity indexing system to the set of machines; constructing a distribution of severity responses associated with the operation classification; mapping a selected range of test event seventies for the operation classification to corresponding target actual seventies for the operation based upon performance of the operation by the machine; and verifying that a target range of test event severities is met using the mapping.

Other features and aspects of this disclosure will be apparent from the following description and the accompanying drawings.

### BRIEF DESCRIPTION OF THE DRAWINGS

The accompanying drawings, which are incorporated in and constitute a part of this specification, illustrate several aspects of the disclosure and together with the description, serve to explain the principles of the disclosure. In the drawings:

FIG. 1 illustrates a machine environment according to embodiments of the present disclosure;

FIG. 2 illustrates a block diagram of a system that may be configured to perform functions according to embodiments of the present disclosure;

FIG. 3 illustrates a flowchart of an exemplary CWC mapping process according to embodiments of the present disclosure;

FIG. 4 illustrates an example histogram of operation severity indices for machines falling within a target confidence interval for a target percentile of severity for a particular severity response; and

FIG. 5 illustrates an example histogram of damage rates collected from severity test or simulation data.

### DETAILED DESCRIPTION

Reference will now be made in detail to aspects of the disclosure, examples of which are illustrated in the accompanying drawings. Wherever possible, the same reference numbers will be used throughout the drawings to refer to the same or like parts or elements.

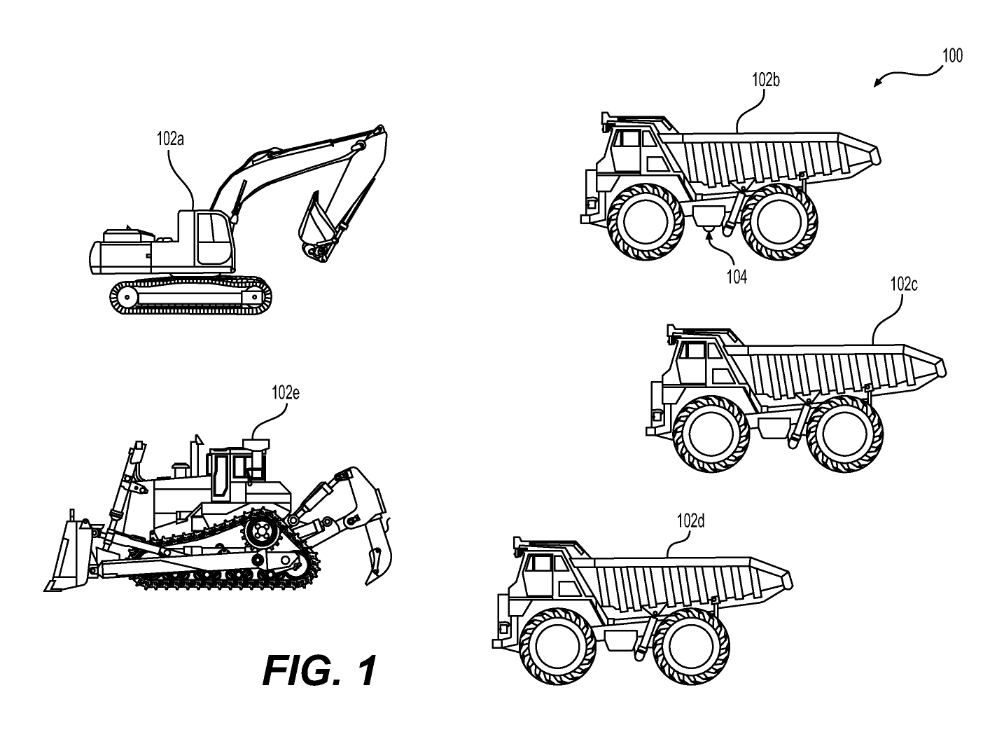

FIG. 1 illustrates a typical worksite 100 where a plurality of machines and or equipment may be deployed to perform a set of work tasks (e.g., a mine site, a construction site, etc.). As shown in FIG. 1, worksite 100 may include one or more machines 102a-102e, hereinafter also collectively referred as machine 102 or machines 102. A machine, as the term is used herein, refers to a fixed or mobile machine that performs some type of operation associated with a particular industry, such as mining, construction, farming, etc. and operates between or within work environments (e.g., construction site, mine site, power plant, etc.). A non-limiting example of a fixed machine includes an engine system operating in an off-shore plant environment (e.g., off-shore drilling platform). Non-limiting examples of mobile machines include commercial machines, such as trucks (e.g., mining trucks, haul trucks, on-highway trucks, off-highway trucks, articulated trucks, etc.), cranes, draglines, pipe layers, earth moving vehicles, mining vehicles, backhoes, loaders (e.g., large wheel loaders, track-type loaders, etc.), shovels, material handling equipment, farming equipment, marine vessels, aircraft, and any type of movable machine that operates in a work environment. Such machines deployed on a worksite (e.g., worksite 100) may be manned machines, autonomous machines or semi-autonomous machines. The machines 102 may also include one or more strain measurement devices 104 (e.g., wireless or wired fatigue nodes, strain gauges, rosettes, or other such devices used to measure strain on machines or machine components) from which strain data may be received by one or more of the above modules (e.g., electronic control module 112).

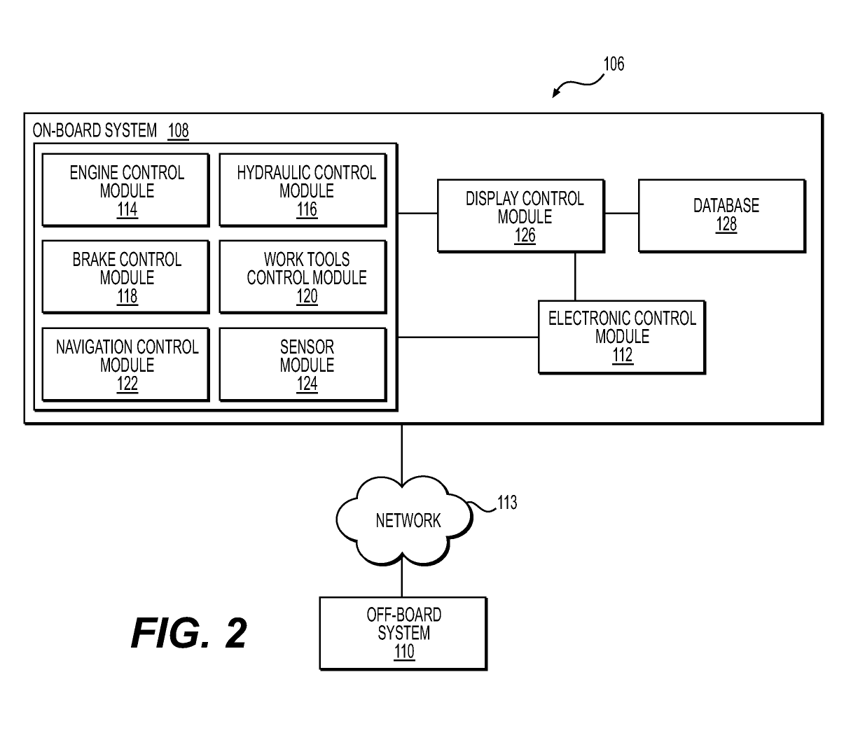

A machine 102 may include on-board communications, monitoring systems, and controls. FIG. 2 illustrates a block diagram of a system 106 that may be configured to perform functions within the environment 100 described in FIG. 1. In some embodiments, system 106 includes an on-board system 108 and an off-board system 110. On-board system 108 may include an operator display device and may include any type of power system control module or attachment interface that connects one or more sub-components. Machine 102 may use the on-board system 108 to facilitate operations of the machine during run time or non-run time conditions (i.e., machine engine running or not running, respectively). For instance, on-board system 108 may include various modules (e.g., electronic control module 112, engine control module 114, hydraulic control module 116, brake control module 118, work tools control module 120, Global Positioning System (GPS)/navigation control module 122, sensor module 124, display module 126 etc. Referring back to FIG. 1, the machines 102 may also include one or more strain measurement devices 104 from which strain data may be received by one or more of the above modules (e.g., electronic control module 112).

It is to be appreciated that on-board system 108, as the term is used herein, may represent any type of component operating in machine 102 that controls or is controlled by other components or sub-components. In one embodiment, the on-board system 108 may be embodied as a remote control station capable of receiving data from one or more control modules (e.g., the engine control module 114) on-board each of the machines 102. In another embodiment, on-board system 108 may be configured to control an operation of the machine 102 based on the monitoring of data (e.g., sensor data, accelerometer data, hydraulic pressure data). One or more modules of on-board system 108 may communicate with other on-board modules to perform various functions related to the operation of the machine 102. For example, display module 125 may receive data from an engine control module 114 via a data link (e.g., a J1939 data link), while engine control module 114 supplies estimated torque and fuel information to hydraulic control module 116 via proprietary data links. In some embodiments, non-control modules may process the data on-board, or data may be processed near-on-board or off-board.

Once strain data is collected, it may then be transferred off-board. Thus, machine 102 or any control component thereof may also be connected to an off-board system 110 (e.g., centralized server, a remote data management system, off-board computing system, etc.) associated therewith. An off-board system, as the term is used herein, may represent a system that is located remote from a machine, such as remote from machine 102. Off-board system 110 may be a workstation, personal digital assistant, laptop, mainframe, etc., and may include one or more computing systems each executing one or more software applications. The off-board system 110 may be implemented on a worksite in a vicinity proximate to one or more worksites (e.g., worksite 100).

Off-board system 110 may include various hardware devices for monitoring of machine data related to the machines operating on the given worksite. For instance, to perform various monitoring and/or control functions, off-board system 110 may include known computing components, such as one or more processors, software, display, and interface devices that operate collectively to perform one or more processes. In certain embodiments, off-board system 110 may include one or more controllers, such as Programmable Logic Controllers (PLCs) that may be used in plants and/or factories. Alternatively, or additionally, the off-board system 110 may include one or more communications devices that facilitate the transmission of data to and from an on-board system (e.g., on-board system 108). Off-board system 110 may also be associated with a user (e.g., customer), multiple users, a business entity (dealer, manufacturer, vendor, etc.), a department of a business entity (e.g., service center, operations support center, logistics center, etc.), and any other type of entity that sends and/or receives information to/from on-board system 108. Further, off-board system 110 may execute off-board software applications that download or upload information to/from on-board system 108 via network.

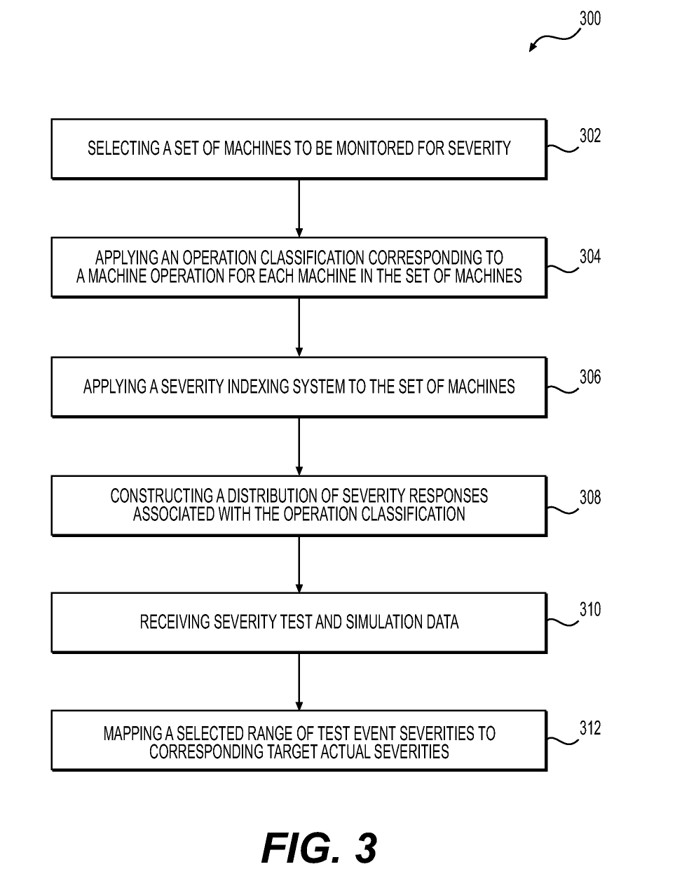

FIG. 3 is a flowchart of a method 300 for aligning composite work cycle severity distributions to target percentile severity responses. It is contemplated that method 300 may be performed in any order suitable for verifying simulated severity test measurements align with actual severity responses, according to embodiments of the disclosure. Method 300 is described for illustration purposes only with respect to the worksite environment and machine components, processes and examples depicted in FIGS. 1-2 and 4-5. However, it should be apparent that method 300 may be employed with other systems and interfaces. Further, the order of operations of FIG. 3 should not be considered limiting.

Method 300 may begin at operation 302, where a set of machines is selected to be monitored for severity. In a preferred embodiment, the set of machines includes one type of machine (e.g., a wheel loader, a track-type tractor, etc.) such as machine 102 described above. The size of the selected set of machines may be determined so as to create a reasonably-sized confidence interval (e.g., 95%) around a desired percentile of severity (e.g., the 90th percentile). Machines that reside within the confidence interval for the selected percentile for a particular severity measure can then be extracted for further examination.

Once the set of machines has been selected, method 300, at operation 304, may apply an operation classification corresponding to one or more machine operations performed by each machine in the set of machines. Such application may also be referred to as operation segmenting. The overall or total severity of machine usage (e.g., by a machine operator) may be primarily determined by at least two variables. One variable may be the mix of equipment events or operators selected to be performed by/using customers the equipment (i.e., some events or operations may be inherently more severe than others). Thus, operation segmentation may define events actually performed by the machine. For instance, a wheel loader may load a truck utilizing one or more components of the wheel loader's large structures subsystem. Using a data segmentation system (sometimes also referred to as an operation classification system) installed on the wheel loader, the system can recognize various operation segments (e.g., “digging,” “loaded carry,” “dumping,” “unloaded travel,” etc.) that comprise the truck loading application based upon measured engine parameters, machine speed, and cylinder positions & pressures. Thus, the various machine operations involved in performing a task can be classified separately. For the purposes of this disclosure, a single operation classification may be used for each severity mapping. Another variable used to determine usage severity may be the intensity with which individual events are executed, since any given event includes a distribution of possible associated severities.

Method 300 may then proceed to operation 306, where a severity indexing system is applied to the set of machines. In order to map the severity of events in a composite work cycle to a targeted percentile of customer severity, in one embodiment, machine usage severity may be measured in a similar manner. According to this embodiment, the method 300 may include dividing measurements of severity into two measurement categories, direct and indirect. A direct measurement of severity may be one that very nearly directly observes a quantity that can be easily transformed into a damage rate. One or more methods may be used to calculate actual damage (e.g., units of cycles/cycles to failure or the rate of damage accumulation per unit of time). In one embodiment, a direct severity measurement may be obtained using the strain measurement device 104 (e.g., a strain gauge rosette) described above, and indexing may be applied. For instance, an on-machine database 128 may receive and store time-fraction segments for time spent in one or more machine operations, with all fractions summing to unity. The strain measurement device 104 may be configured to measure strain which can then be transformed into a fatigue damage rate. In some embodiments (e.g., for drivetrain components) torque and RPM may be used for direct measurements of severity, upon transformation of the torque and/or RPM information to strain at various locations and then to fatigue damage rate.

An indirect measurement may also be calculated. For instance, to derive an indirect measurement of severity, empirical relationships may be established between structural damage rates at various locations on a machine (e.g., a wheel loader) and the power expenditure of various hydraulic cylinders and the rate of change of kinetic energy of the machine. The parameters of the empirical relationship may also depend upon the current operation classification of the machine. Individual severities for events may also have been previously established or derived from standard test procedure documents for events. Additionally, a formally specified CWC may include a set of severity weightings associated with a list of events. For instance, in the large structures arena, a test life goal may be typically stated in a format such as: “A 90th percentile machine shall have a composite life of X engine-hours at sensor location Y assuming a B50 SN curve corresponding to its weld class.”

Once direct and/or indirect severity measurements are collected, method 300 may then proceed to operation 308, where a distribution of severity responses associated with an operation classification is constructed. In some embodiments, the total severity index for a particular response over all operations for a selected machine may also be quantified. Thus, each machine may have a corresponding total severity index for a particular response. Severity index data for an individual machine may be received data and then ranked in order. In some instances, the order may be designated by the machine manufacturer and may correspond to durability goals (e.g., users at the 90th percentile of severity in usage will preferably have a B50 life of roughly X-thousand hours). From this ranked list, a percentage confidence interval (e.g., 95%) for a selected target percentile (e.g., 90th percentile) in total severity may be obtained, and machines whose total severity lies within that confidence interval may be identified.

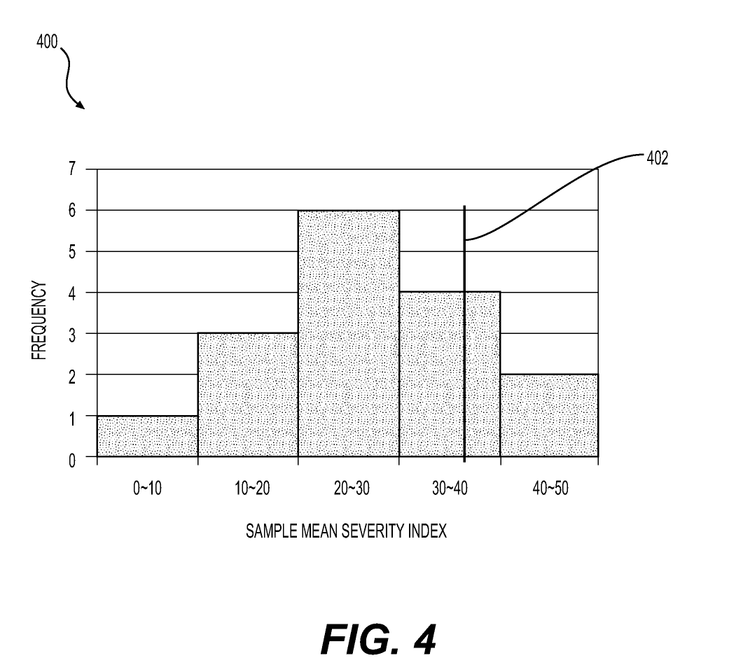

In some embodiments, the distribution may be constructed as a histogram. That is, for a given operation, a histogram may be constructed for a severity index using data taken from all machines that fell within the confidence interval described above. FIG. 4 illustrates an example histogram 400 of operation severity indices for machines falling within a target confidence interval for a target percentile of severity for a particular severity response. This histogram may represent the observed variability in the severity index for a given operation between machines that are suspected of being near the target (e.g., 90^{th}) percentile in total severity. Each histogram may include a sample mean severity index, designated by indicator line 402. The sample mean severity index indicator line 402 may represent a damage rate goal for a target percentile severity for the selection of machines.

Method 300 may then proceed to operation 310, where data from one or more performed damage simulations or tests is received. As described above, a CWC may be defined as a standard list of events and severities that are used in simulation or test of a new design to prove it can meet the durability targets. In some instances, a selected operation may be simulated (e.g., in a Monte Carlo exercise or during a test at a proving ground), where the operation is included in a test CWC. Simulated damage or severity test data may be received by the processor performing one or more other operations of the method, or may alternatively be received by any other means capable of performing the below described operations.

Method 300 may then proceed to operation 312, where a selected range of test event severities for the operation classification are mapped to corresponding target actual severities for the operation based upon performance of the operation by the machine. In one embodiment, actual severity responses may be mapped to an average severity index constructed for test or simulation severity data. It would be desirable for the simulated or tested sample mean severity index to be accurately categorized as a member of the same population sampled by the histogram of target percentile machines' sample mean severity index, as illustrated by the sample mean severity index indicator line 402 in FIG. 4.

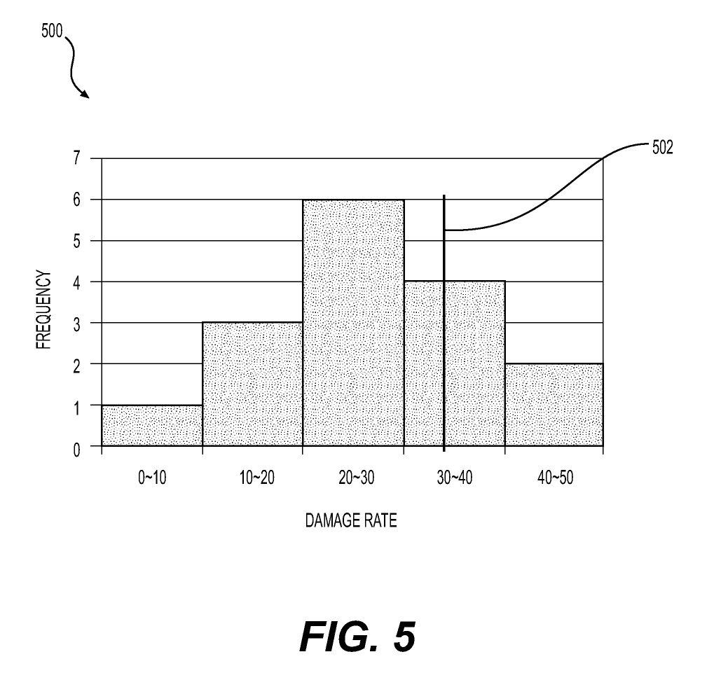

In addition, method 300 may compare a damage rate goal for a target percentile of machines to collected test or simulation severity data. FIG. 5 is a histogram 500 illustrating damage rates collected from severity test or simulation data as described above. Assuming that individual operations are being simulated and/or tested at an appropriate severity, method 300 may utilize the simulation or test results to calculate a damage rate for the ensemble of operation classification fractions that was applied to machines that were in the target confidence interval (e.g., 95%) for the target percentile (e.g., 90^{th}) of severity. The sample of damage rates may then be generated and expressed in histogram 500. Method 300 may provide visual verification that a target range of test event severities is met using the mapping. For example, if the damage rate goal indicator line 502 is a believable member of the same population from which the histogram data was drawn (as illustrated in FIG. 5), or is at least close to the population of damage rate goals in an absolute sense, then a target severity testing level may be determined to have been achieved. If damage rate goal indicator line 502 is too far to the right or to the left of the clustering of histogram data, this may indicate over-design or under-design, respectively, of a damage simulation.

Simulated or test severity calculations for a particular operation may be compared to the histogram. If tested or simulated severity falls within the histogram, then severity testing or simulation is determined to be accurate. If tested or simulated severity lies outside the histogram, then one or more modifications to the severity test or simulation (or to severity calculations) may be made to align the results with the histogram. In this manner, each machine operation is executed or simulated in an expected manner for users using the machines at or near a target percentile (e.g., 90^{th} percentile users) of overall severity.

In some instances, when a target confidence interval (e.g., a 95% confidence interval) for a target percentile (e.g., the 90th percentile) is identified for each severity response, and then machines having severity responses in these intervals are also identified, it may be determined that one or more machines performs a potentially different operation mix than one or more other machines in the sample. Under normal test circumstances, when calculating life after a machine test at our proving grounds (assuming the individual event severity requirement described above has been met), an assumption may be made regarding an operation mix (i.e., a composite work cycle) for the machine as part of the overall composite life calculation process. However, in some embodiments, a repeat a life calculation process (e.g., at a proving grounds or test facility) may be performed for all or substantially all observed operation mixes applicable to the machines in the sample.

Upon performing the above calculations for a variety of operation mixes, a distribution (e.g., a histogram) may be created for calculated test life of the machines. An analysis may then be performed to determine if the resulting histogram includes a life goal for the machines specified in the sample. If not, further design improvements may be made for cost reduction or the test life may be readjusted to account for any inadequacies.

Accordingly, method 300 examines whether a test or simulation severity response for a particular event is in the family of severity responses of possible target percentile customers for that same event in the CWC and determines whether simulated or test events are performed at a reasonable intensity for a particular response.

It should be appreciated that any of the above described components may embody a single microprocessor or multiple microprocessors known in art. Numerous commercially available microprocessors may be configured to perform the functions of the methods described herein. It should also be appreciated that on and off-board modules used to perform the described methods or systems may readily embody a general microprocessor. A person of ordinary skill in the art will appreciate that on and off-board modules or systems may additionally include other components and may also perform other functionality not described herein. It should be understood that the embodiments, configurations and connections explained herein are merely on an exemplary basis and may not limit the scope and spirit of the disclosure.

### INDUSTRIAL APPLICABILITY

Methods and systems consistent with embodiments of the present disclosure allow for CWC events to be defined in such a way so as to create a minimum set of events that adequately span the space of possible received severity responses and that map to the targeted percentile of reported severity. In one embodiment, the method includes selecting a set of machines to be monitored for severity, applying an operation classification corresponding to one or more machine operations performed by each machine in the set of machines, applying a severity indexing system to the set of machines, constructing a distribution of severity responses associated with an operation classification, receiving data from one or more performed damage simulations or tests, and mapping a selected range of test event seventies for the operation classification to corresponding target actual severities for the operation based upon performance of the operation by the machine. Such a mapping will provide an indication as to whether severity testing is being performed at target levels. Therefore, costs will be reduced for product development for both test and simulation-related activities.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for aligning composite work cycle seventies to target percentile severity responses comprising:
selecting a set of machines to be monitored for severity;
applying an operation classification corresponding to one or more machine operations performed by each machine in the set of machines;
applying a severity indexing system to the set of machines;
constructing a distribution of severity responses associated with an operation classification;
receiving data from one or more performed damage simulations or tests; and
mapping a selected range of test event seventies for the operation classification to corresponding target actual seventies for the operation based upon performance of the operation by the machine.

2. The method of claim 1, wherein each of the machines in the selected set of machines is the same.

3. The method of claim 1, wherein applying an operation classification includes:
recognizing a plurality of operation segments that comprise a machine operation based upon receiving one or more measured machine parameters.

4. The method of claim 3, wherein the parameters include engine parameters, machine speed, cylinder position, and cylinder pressure.

5. The method of claim 1, wherein applying a severity indexing system includes:
receiving at least one of a direct or indirect severity measurement relating to an operation, wherein the direct severity measurement is measured at one or more locations on the machine and the indirect severity measurement is calculated at one or more locations on the machine; and
using the received direct or indirect severity measurement to quantify a total severity index for the operation for at least one machine in the selected set of machines.

6. The method of claim 5, wherein a direct severity measurement is obtained using a strain measurement device.

7. The method of claim 5, wherein the constructing a distribution of severity responses includes:
constructing a histogram for the total severity index, wherein the histogram includes operation severity indices for machines falling within a target confidence interval for a target percentile of severity for a particular severity response, and wherein the histogram represents an observed variability in the total severity index for a respective operation between machines that are determined to fall within a target percentile of total severity.

8. The method of claim 7, wherein the histogram includes a sample mean severity index indicator line.

9. The method of claim 1, further including;
comparing a damage rate goal for a target percentile of machines to collected test or simulation severity data.

10. The method of claim 9, further including:
utilizing simulation or test results to calculate a damage rate for an ensemble of operation classification fractions applied to one or more machines in a target confidence interval for a target percentile of severity to generate the histogram, wherein the histogram also includes a damage rage goal indicator providing a visual indication that a target range of test event severities is met.

11. A method for aligning composite work cycle seventies to target percentile severity responses comprising:
selecting a set of machines to be monitored for severity;
applying an operation classification corresponding to a machine operation for each machine in the set of machines;
applying a severity indexing system to the set of machines;
constructing a distribution of severity responses associated with the operation classification;
mapping a selected range of test event seventies for the operation classification to corresponding target actual seventies for the operation based upon performance of the operation by the machine; and
verifying that a target range of test event seventies is met using the mapping.

12. The method of claim 11, wherein each of the machines in the selected set of machines is the same.

13. The method of claim 11, wherein applying an operation classification includes:
recognizing a plurality of operation segments that comprise a machine operation based upon receiving one or more measured machine parameters.

14. The method of claim 13, wherein the parameters include engine parameters, machine speed, cylinder position, and cylinder pressure.

15. The method of claim 11, wherein applying a severity indexing system includes:
receiving at least one of a direct or indirect severity measurement relating to an operation, wherein the direct severity measurement is measured at one or more locations on the machine and the indirect severity measurement is calculated at one or more locations on the machine; and
using the received direct or indirect severity measurement to quantify a total severity index for the operation for at least one machine in the selected set of machines.

16. The method of claim 15, wherein a direct severity measurement is obtained using a strain measurement device.

17. The method of claim 15, wherein the constructing a distribution of severity responses includes:
constructing a histogram for the total severity index, wherein the histogram includes operation severity indices for machines falling within a target confidence interval for a target percentile of severity for a particular severity response, and wherein the histogram represents an observed variability in the total severity index for a respective operation between machines that are determined to fall within a target percentile of total severity.

18. The method of claim 17, wherein the histogram includes a sample mean severity index indicator line.

19. The method of claim 11, further including:
comparing a damage rate goal for a target percentile of machines to collected test or simulation severity data.

20. A computer-readable medium including a processor configured to execute instructions stored on the computer-readable medium to perform a method for aligning composite work cycle severity distributions to target percentile severity responses comprising:
selecting a set of machines to be monitored for severity;
applying an operation classification corresponding to a machine operation for each machine in the set of machines;
applying a severity indexing system to the set of machines;
constructing a distribution of severity responses associated with the operation classification;
mapping a selected range of test event seventies for the operation classification to corresponding target actual seventies for the operation based upon performance of the operation by the machine; and
verifying that a target range of test event seventies is met using the mapping.
